(19) United States
(12) Patent Application Publication
(10) Pub. No.: US 2006/0001761 A1
(43) Pub. Date: Jan. 5, 2006

(54) Hermetically sealed image sensor module and method of fabricating same

(75) Inventors: Belgacem Haba, Saratoga, CA (US); David B. Tuckerman, Orinda, CA (US)

Correspondence Address: STEVENS LAW GROUP, P.O. BOX 1667, SAN JOSE, CA, 95109, US

(73) Assignee: Tessera, Inc., San Jose, CA (US)

(21) Appl. No.: 11/014,280

(22) Filed: Dec. 15, 2004

Related U.S. Application Data
(60) Provisional application No. 60/532,365, filed on Dec. 23, 2003.

(51) Int. Cl. H04N 5/225

(52) U.S. Cl. 348/340

(57) ABSTRACT

A solid-state image sensor including a package with an element for both covering and protecting the sensor device and also filtering portions, e.g., infrared portions, of the incident light beam. The image sensor module includes a package to receive the image sensor integrated circuit chip, with the image sensor integrated circuit chip being bonded to the package, and an infrared filter overlaying the image sensor integrated circuit chip and likewise bonded to the package. This provides both a hermetic seal for the image sensor integrated circuit chip and filters or attenuates the incident infrared light.

### PRIOR APPLICATION

This application claims priority from U.S. Provisional Patent Application No. 60/532,365 filed Dec. 23, 2003.

### BACKGROUND OF THE INVENTION

The invention relates to solid-state image sensors including a package with an element for covering and protecting the sensor device while filtering portions of the incident light beam.

Solid state integrated circuit images sensors, such as for example CCD's (Charge Coupled Devices), and CMOS integrated circuits are ubiquitous particularly with respect to their use as solid state image sensors. The cost of CCD's has fallen over time and, the pixel population of CCD's has grown with the resolution of the resulting imaging devices growing concomitantly. As a result, whole new consumer markets have been created, including cellular picture phones, web cameras, and consumer digital cameras. The packaged CCD integrated circuit chip has become an essential building block of these consumer products. Accordingly, this packaged CCD integrated circuit chip, with associated memory and logic, must itself be a rugged and reliable module to withstand consumer use, misuse, and abuse.

It is also necessary to protect the delicate structure of images sensor integrated circuit chips, such as CCD integrated circuit chips, CMOS integrated circuit chip (including layered CMOS chips and amorphous Si CMOS chips) from contamination, including contact with the atmosphere, moisture, dust, and atmospheric contaminants. This is for the purpose of insuring longevity and stability of operation. This problem is common with many other microelectronic and optical components. A typical application of integrated circuit image sensor chips, is found in consumer goods, such as cameras, camcorders, and cellular picture phones. In these consumer goods, the CMOS and CCD modules are subject to heavy impacts in their common use. It is therefore desirable to encapsulate such image sensor integrated circuit chips and associated and ancillary and auxiliary chips in a rugged hermetic package.

A CCD Module is actually a monolithic array of many individual charge coupled devices on a single integrated circuit chip. The individual devices are arranged in the form of registers, equivalently referred to as pixels, or CCDs. In terms of individual pixel device physics, each pixel has a storage potential well or opening. This storage potential well enables an individual register, pixel, or device to collect photogenerated minority carriers. The collected charges are then “shifted” down the array and converted into currents or voltages at the output terminal of the array.

The monolithic structure of CCD's, each typically less than 0.07 millimeter on a side, is a cascading array of MOS (metal oxide semiconductor) capacitors. This structure is shown schematically FIG. 1, denominated “Prior Art.” In the example shown in FIG. 1, the voltage pulses are supplied in three lines, 101, 103, 105. Each line is connected to every third gate, and the array illustrated in FIG. 1 is called a “three phase CCD.” Two phase and four phase CCD's are also used.

Initially, the G1 gates are turned on, resulting in an accumulation and storage of charge under the gates. Thereafter, G2 is turned on, resulting in a charge equalization step across two thirds of each cell. Then, G1 is turned off, resulting in a complete transfer of charge to the middle one third of each cell. This process is repeated to transfer charge to the last one third of each cell. After a full cycle of clock voltages has been completed, the charge packets shift to the right by one cell in “bucket brigade” fashion. The result is that charge packets proportional to the light intensity on an individual pixel are formed and shifted to a detector for final readout.

Referring to FIG. 2, denominated “Prior Art,” a system 200 is illustrated having MOS transistors, 201, along with a photodiode, 203, array, both of which can be embedded in the same monolithic structure. This system performs sequential readout. In the system of FIG. 2, a voltage pattern is generated from the shift register, 205, so as to turn on one transistor, 201, at a time. This switching voltage is shifted serially around all of the photodiodes, 203.

The scheme of the one dimensional array of FIG. 2, is extended to the two dimensional array of FIG. 3, also denominated “Prior Art.” Here the diodes of one row, 301, are switched on, and all of the columns, 303, are then scanned sequentially. This process is repeated for all of columns of a row, and then for all of the rows.

An individual CCD integrated circuit die may actually contain between a megapixel or less to tens of megapixels. Conventionally, individual CCD integrated circuit die are bonded into or onto a ceramic package, and electrical contacts are used to make electrical connection between the CCD integrated circuit chip and the package headers. A glass lid is suitably joined, for example, adhesively joined, soldered or welded, on to the package to complete and hermetically seal the enclosure.

While this approach is technically and economically feasible, it is not all together satisfactory. This is because solid state image sensors, for example CCD sensors and CMOS sensors, have a high sensitivity to infrared light and, more particularly, a higher sensitivity to infrared than to the rest of the visible and ultraviolet spectrum. This is called “infrared leak.” Infrared leak is the substantial leak of infrared light beyond about 700 nanometers. This infrared light is transmitted in addition to the intended colored light of the 400 nM-700 nM visible spectrum.

For visual and most photographic applications, the infrared leak is not a significant concern. This is because the human eye and standard photographic films are not sensitive to infrared wavelengths. However, digital cameras in general, and CCDs used for certain imaging applications in particular, are profoundly affected by infrared and infrared leakage. Thus, infrared leak is indeed a problem in such applications. Digital cameras exhibit strong response at near-infrared wavelengths from 700 to beyond 1100 nanometers. The infrared is recorded just as if it were part of the intended transmittance in the visible (400-700 nM range). The result is a gross over-representation of the true intensity of the colored light actually being recorded.

Infrared leakage means that conventional solid state sensors are not uniformly panchromatic. As a result of infrared leakage, integrated circuit solid state sensors, such as CCD sensors, require optical filtration to avoid chromic aberrations, with apparent “overexposure” of red reflecting and emitting items (such as animals and people). This optical filtration is an additional optical layer, with two additional air-glass surfaces. This results in the attendant possibilities for internal reflections, light absorption, additional chromic aberrations, and astigmatic aberrations. The materials, the provision of multiple optical layers, and the number of processes and labor involved in this packaging method add considerable cost to the finished component (such as a sub-assembly of a digital camera) relative to the cost of what should be a low cost module for a low cost, mass marketed consumer item.

It would be desirable to integrate the hermetic sealing the image sensor integrated circuit chip, be it a CCD chip or a CMOD chip or a variant of a CMOS chip, with an infrared filter to both protect the delicate chip surface and to reduce unsightly and chromatically distorting chromic aberrations while providing an infrared blocking or attenuating filter. As will be seen the invention accomplishes this in an elegant manner.

### THE FIGURES

Various aspects of the invention are illustrated in the Figures appended hereto and made a part hereof.

FIG. 1 is a general schematic view of a charge coupled device photosensor of the Prior Art showing a cascading array of MOS capacitors.

FIG. 2, denominated “Prior Art” shows a linear array of a charge coupled device having MOS transistors in series with photodiodes.

FIG. 3, denominated “Prior Art” shows a charge coupled device photosensor having a two dimensional array of photodiodes and MOS transistors with shift registers and a clock.

FIG. 4 is a high level over view of a charge coupled device photosensor system of the invention with a charge coupled device integrated circuit chip, an IR filter and hermetic seal, image circuitry and logic, addressing circuitry and logic, a processor, and further connections out to, for example, a display and storage.

FIG. 5 is an exploded perspective view of a CCD photosensor module of one embodiment of the invention having a CCD integrated circuit chip overlaid on the package, with the seal surrounding the CCD integrated circuit chip.

FIG. 6 is a cutaway elevation of the CCD photosensor shown in FIG. 5.

FIG. 6B is an alternative embodiment of the module shown in FIGS. 5 and 6, with external electrical contacts shown above the substrate and bonded to the substrate.

FIG. 7 is a further view of the module shown in FIGS. 5 and 6, with the external electrical contacts shown.

FIG. 8 is an exploded perspective view of a CCD photosensor module of another embodiment of the invention having a CCD integrated circuit chip mounted within a ridged package adapted to receive the CCD integrated circuit chip within a walled recess within the package, where the package walls surround the CCD integrated circuit chip, and the IR filter is bonded to the package walls.

FIG. 9 is a cutaway elevation of the CCD photosensor shown in FIG. 7.

FIG. 10 is a further view of the module shown in FIGS. 7 and 8, with external electrical contacts shown.

FIG. 11 is an alternative embodiment of the module shown in FIGS. 8 and 9, with external electrical contacts shown above the substrate and bonded to the substrate.

FIG. 12 is a perspective view of a module of one exemplification of the invention further including additional logic as part of the system, here an address and driver ship.

FIG. 13 is a perspective view of a module of one exemplification of the invention further including additional logic as part of the system, here an address and driver ship.

FIG. 14 shows one application of the CCD photosensor module of the invention as a component of an integrated camera and cellular telephone.

FIG. 15 shows another application of the CCD photosensor module of the invention as a component of a digital camera, including a lens assembly.

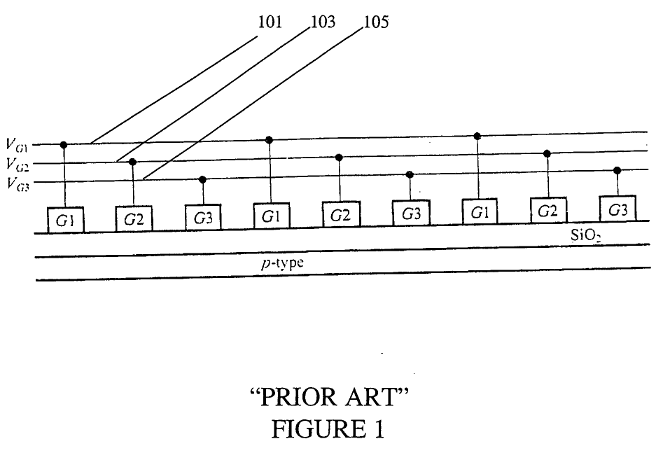

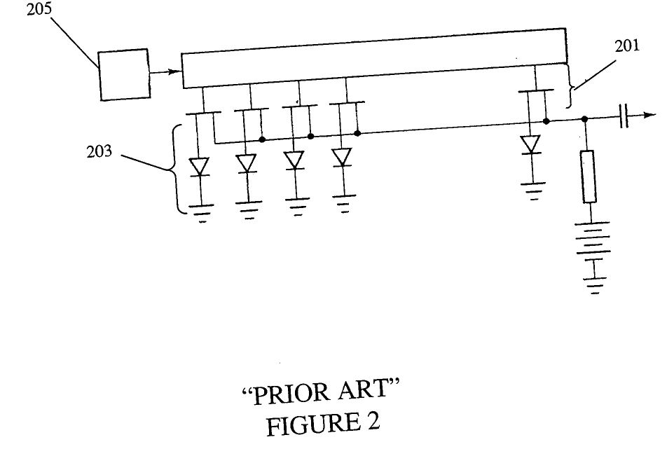

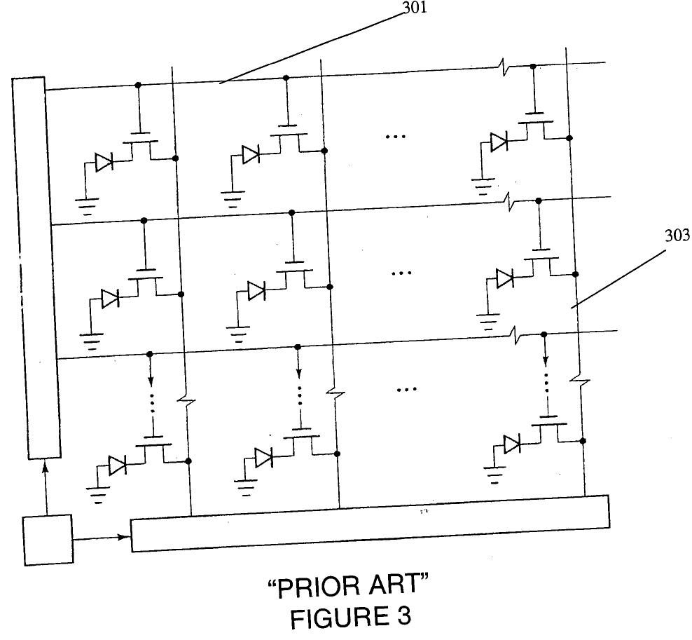

### DETAILED DESCRIPTION

The invention overcomes these limitations, substantially reducing the chromic aberrations of prior art infrared filters. Furthermore, it does so with fewer manufacturing steps and potentially lower manufacturing costs, and provides for additional advantages.

The invention pertains to a method of hermetically packaging a discrete image sensor integrated circuit chip, as a CCD chip or a CMOS chip or variant thereof in a package to form an infrared blocking or attenuating, hermetically sealed package, and the resulting structure. The method avoids exposing the chip to harmful chemicals, including moisture. Therefore, it is ideally suited to image sensor integrated circuit chips and image sensor devices, including CCD integrated circuit chips, CMOS integrated chips, and variants of CMOS integrated circuit chips.

A hermetic package is a sealed enclosure that prevents exchange of atmosphere between the inside and outside of the package. As there is no such thing as a truly leak-free enclosure, hermeticity needs to be specified as a maximum permissible leak rate for each application. For example, for many silicon semiconductor devices a package is considered to be hermetic if it has a leak rate of helium below 1×10⁻⁸ Pa m³/sec.

One of the key difficulties of fabricating hermetic packages is that it is usually also necessary to include means of conveying electrical signals, and optical signals (including optical image information) thorough the package wall, to the sensor elements of the CCD integrated circuit chip, and then to convey the resulting electrical signals off of and outside the module. Moreover, a hermetic seal is expected to actually act as a hermetic seal in operation it is required to actually provide hermetic sealing during exposure to the diversity of adverse external environmental attacks that cameras and cellular telephones encounter during normal service conditions and end user operation.

Described herein is an image sensor module having a package adapted to receive and protect a CCD or CMOS image sensor integrated circuit chip. The CCD integrated circuit chip is electrically and mechanically (metallurgically or adhesively) bonded to the package and hermetically shielded from the environment by an infrared blocking or attenuating optical filter. In the case of a CCD integrated circuit chip, the CCD integrated circuit chip has a megapixel scale array of serially addressable, serially readable sensors adapted to collect and store photogenerated minority carriers. The CCD further includes a switchable circuit for sequentially reading individual pixel level sensors. These individual readings are in the form of cascading readings of the individual, pixel level sensors. This is carried out in a “bucket brigade” manner. Further included are electrical connections for receiving a driving signal for sequentially, i.e., bucket brigade style, reading the individual sensors and for outputting the sequential readings.

The module described herein includes an infrared attenuating or blocking filter overlaying the image sensor integrated circuit chip and hermetically sealably bonded to the package. The infrared filter is both an optical filter and, when bonded to the package, a hermetic seal. In one embodiment the integrated circuit chip is overlaid on a substantially planar package, and the hermetic seal surrounds the integrated circuit chip, bonding the filter sheet to the package.

In an alternative embodiment of the invention, a recessed package receives the image sensor integrated circuit chip, and the image sensor integrated circuit chip is contained within the package. In this embodiment package walls surround the image sensor integrated circuit chip, and the IR (infrared) filter sheet is bonded to the package walls, forming a hermetic seal. The hermetic seal may be a solder bond or an adhesive bond that is a cured or thermoplastic or thermoset resin bond. Those skilled in the art will understand that other processes are available, and that the invention is not limited to the various processes that can be employed.

The module has electrical connections with other parts of the camera, picture phone, or the like. These include, strictly by way of example, first electrical pads on the package for electrical connection to the image sensor integrated circuit chip (be it CCD, CMOS, or a CMOS variant), and second electrical pads on the package for electrical connection from the package to circuit components. The degree of integration is a design choice, and the invention is not limited to any particular degree of integration. Integration may include, for example, off package or on-package image logic, off package or on-package addressing logic, and off package or on-package system logic or CPU.

In a further embodiment of the invention, the module can include a lens assembly, where the lens refractive elements are spaced from the IR filter, and the lens assembly is joined or bonded to the module, for example to the IR filter or the chip package, and where the lens is either movable for selective focus or the lens (owing to its short focal length) is fixed focus.

Depending on the intended end use of the module, the module may include a display, for example, a liquid crystal display with appropriate display logic. This is where the module is intended for incorporation in, for example, a camera or a cellular telephone. The packaged module may be arrayed for either direct bonding of the bottom surface or bonding of the top surface.

In one embodiment, the invention provides an image sensor module having a package adapted to receive an image sensor integrated circuit chip. An image sensor integrated circuit chip is bonded to said package, and includes an array of addressable, readable sensor pixels adapted to collect and store photogenerated minority carriers, a switchable circuit for reading individual sensors andelectrical connections for receiving a driving signal for reading said individual sensors and for outputting the readings. The image sensor module further includes an infrared filter overlaying the image sensor integrated circuit chip and bonded to said package, first electrical pads on said package for electrical connection to said image sensor integrated circuit chip and second electrical pads on said package for electrical connection from said package to circuit components. The infrared filter may be sealably bonded to the package, and may form a hermetic seal with the package. The infrared filter may also be solder bonded to the package at a solder joint, or may be bonded to the package at an organic adhesive bond. The infrared filter may also be a glass sheet, or a polymeric sheet that is chosen from the group consisting of polycarbonate sheets and poly diethyleneglycol bis (allyl carbonate) sheets. The image sensor integrated circuit chip may be overlaid on the package.

The package may be a recessed package with a recess configured to contain the image sensor integrated circuit chip within the package, and may include package walls to surround the image sensor integrated circuit chip. The infrared filter may be bonded to the package walls, and a bonding seal may surround the image sensor integrated circuit chip.

The package may further include leads directed to off-package image logic, and may alternatively include on-package image logic. The package may further include leads directed to off-package addressing logic, on-package address log, as well as on or off package system logic. The package may also have a combination of different connections.

The image sensor module may also include a lens assembly for forming an image on the integrated circuit chip and a refractive lens element, wherein the lens assembly is joined to the module. The lens assembly may be joined to the infrared filter. The lens assembly may be joined to the package. The package may further include a display including display and display logic. The image sensor module may have a single substrate for bonding with a circuit board. The image sensor module may be adapted for electrical bonding from a substrate atop the package. The image sensor integrated circuit chip may be a CCD integrated circuit chip.

The CCD integrated circuit chip may include an array of serially addressable, serially readable sensors adapted to collect and store photo-generated minority carriers, a switchable circuit for sequentially reading individual sensors and electrical connections for receiving a driving signal for sequentially reading said individual sensors and for outputting the sequential readings. The image sensor integrated circuit chip may be a CMOS integrated circuit chip. The CMOS integrated circuit chip may include a plurality of pixels, a pixel comprising a photodiode for converting light to electrons, a charge-to-voltage conversion section, a reset and select transistor and an amplifier section, or may include a combination of these elements. The CMOS integrated circuit chip may further include a grid of metal interconnects to apply timing and readout signals, and an array of column output signal interconnects. The column output signal interconnects may connect to a set of decode and readout electronics.

In another embodiment, the invention provides an image sensor module that comprises a package adapted to receive an image sensor integrated circuit chip; a image sensor integrated circuit chip bonded to said package; an infrared filter overlaying the image sensor integrated circuit chip and bonded to said package at a hermetic seal with the package; first electrical pads on said package for electrical connection to said image sensor integrated circuit chip; second electrical pads on said package for electrical connection from said package to circuit components; and on-package image processing logic, addressing logic, and system logic. The embodiment may also include a combination of these elements.

In another implementation may provide a digital camera comprising an integrated circuit image sensor module having a package adapted to receive an image sensor integrated circuit chip; an image integrated circuit chip bonded to said package; an infrared filter overlaying the image integrated circuit chip and bonded to said package at a hermetic seal with the package; first electrical pads on said package for electrical connection to said CCD integrated circuit chip; and a lens assembly for a refractive lens element for forming an image on the CCD integrated circuit chip, wherein the lens assembly is joined to said module. The lens assembly may be joined to the infrared filter, or to the package. The digital camera may further include a display that includes display and display logic. The embodiment may also include a combination of these elements.

The invention further provides a cellular telephone including an integrated circuit image sensor module having a package adapted to receive an image sensor integrated circuit chip; an image sensor integrated circuit chip bonded to said package; an infrared filter overlaying the image sensor integrated circuit chip and bonded to said package at a hermetic seal with the package; first electrical pads on said package for electrical connection to said image sensor integrated circuit chip; a lens assembly for a refractive lens element for forming an image on the image sensor integrated circuit chip, wherein the lens assembly is joined to said module; and a display including display and display logic. The embodiment may also include a combination of these elements.

The invention further provides a method of hermetically encapsulating an image integrated circuit chip that includes providing a package having a recess defined by peripheral walls and an inner surface including a first surface for an image sensor integrated circuit chip and at least one predefined area defining an electrical contact; placing an image sensor integrated circuit chip on the first surface of the package with an adhesive between the first surface and the image sensor integrated circuit chip; placing a conductive material within the recess and in contact with the image sensor integrated circuit chip and performing a heating process. The purpose of heating process may include causing the conductive material to make an electrical contact between the image sensor integrated circuit chip and the at least one predefined area defining an electrical contact to thereby electrically connect the image sensor integrated circuit chip and the at least one predefined area defining an electrical contact and to fuse the adhesive to bond the image sensor integrated circuit chip to the first surface of the package; and providing an infrared filtering sheet sealably on the walls of the package. The process may further include applying a bond material to the package to allow a hermetic sealing between the filtering sheet and the package.

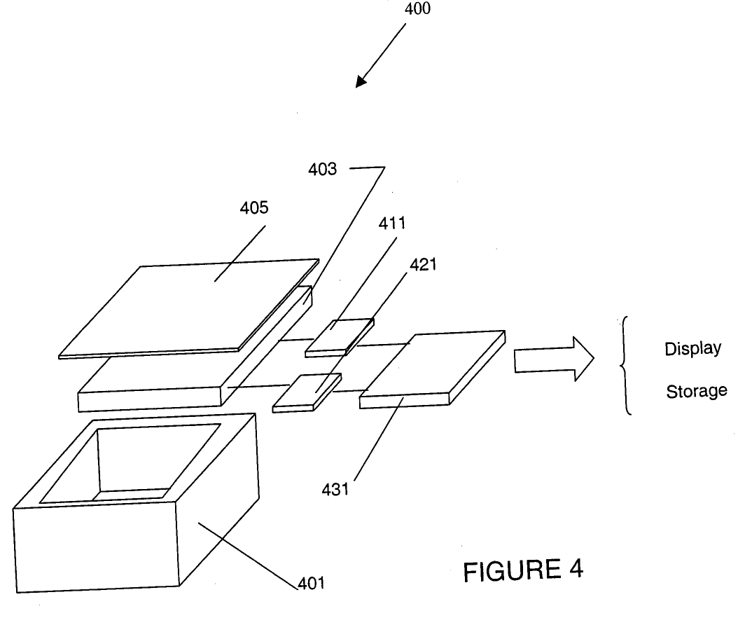

Described herein is an image sensor module where the image sensor integrated circuit chip is hermetically sealed and protected from the elements by an infrared blocking or attenuating filter. FIG. 4 is a general schematic overview of an image sensor module, 400, having a chip package, 401, a charge coupled device integrated circuit chip, 403, an infrared filter sheet, plate, layer, or film, 405, as a hermetic seal with the chip package, 401, image circuitry and logic, 411, addressing circuitry and logic, 421, system logic, and outputs, 431, to, for example, a display and storage.

The package, 401, is adapted to receive the image sensor integrated circuit chip, 403, with the image sensor integrated circuit chip, 403, being suitably bonded to the package, 401. The image sensor integrated circuit chip, 403, though not shown, may contain an array of serially addressable, serially readable sensors adapted to collect and store photogenerated minority carriers, a switchable circuit for sequentially reading individual sensors adapted for cascading readings of the individual, pixel level sensors in “bucket brigade” fashion and electrical connections for receiving a driving signal for sequentially reading the individual sensors and for outputting the sequential readings and may be a combination of these and other elements. Those skilled in the art will understand that these and other image sensor circuits exist in the art.

Also shown is an infrared filter, 405, overlaying the CCD integrated circuit chip, 403, and bonded to the package, 401. By an infrared filter, 405, is meant a filter that partially blocks the passage of infrared light, (that is, typically light in the 700-1100 nM range, and generally in the 720-1000 nM range) blocking or attenuating about 10 percent of the incident light in the range of from about 700 nanometers to about 1100 nanometers, and generally from about 720 nanometers to about 1000 nanometers, with minimal distortion of visible light in the 400 nanometer to 700 nanometer range.

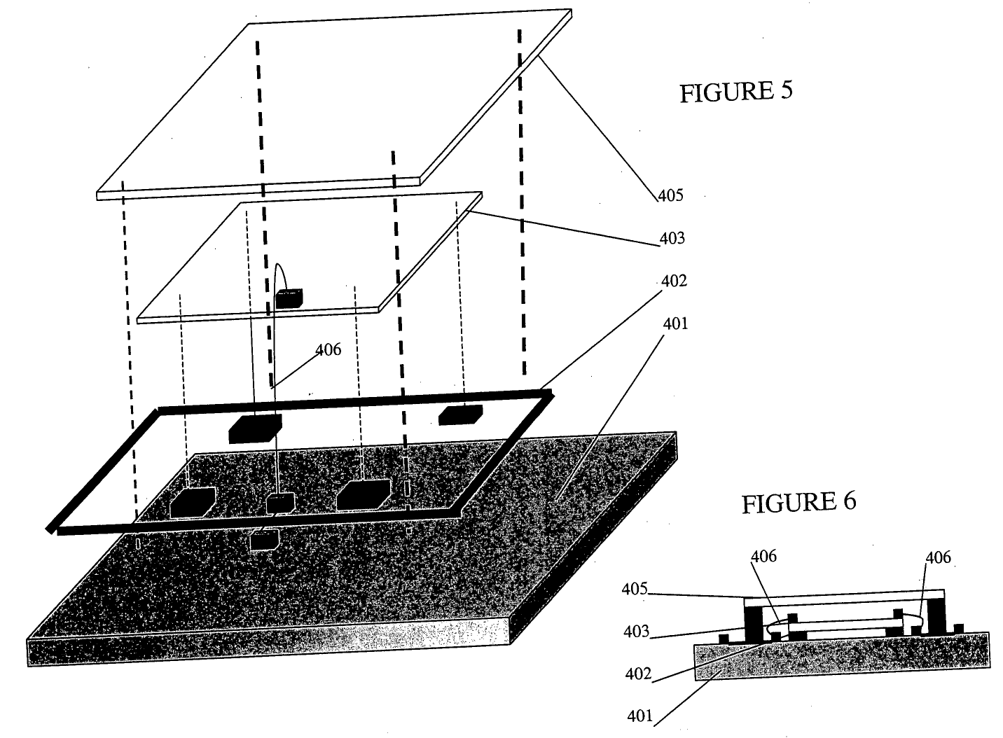

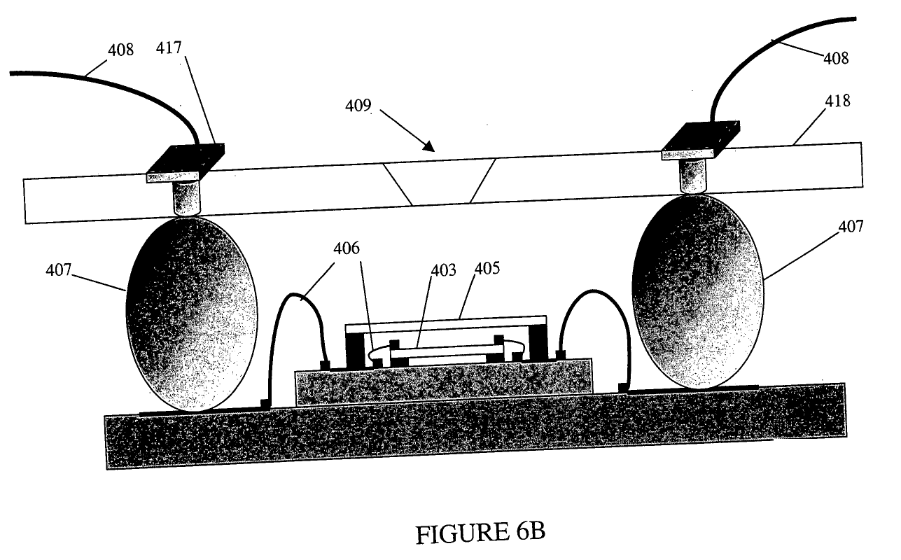

In the embodiment shown in FIGS. 5 and 6, the image sensor integrated circuit chip 403, is overlaid on the substantially planar package, 401, and a seal, 402, surrounds the image sensor integrated circuit chip, 403 binding and hermetically sealing the infrared filter, 405.

FIG. 5 is an exploded perspective view of a photosensor module of one embodiment of the invention having an image sensor integrated circuit chip, 403, overlaid on the package, 401, with the seal, 402, surrounding the image sensor integrated circuit chip, 403. FIG. 6 is a cutaway elevation of the photosensor shown in FIG. 5.

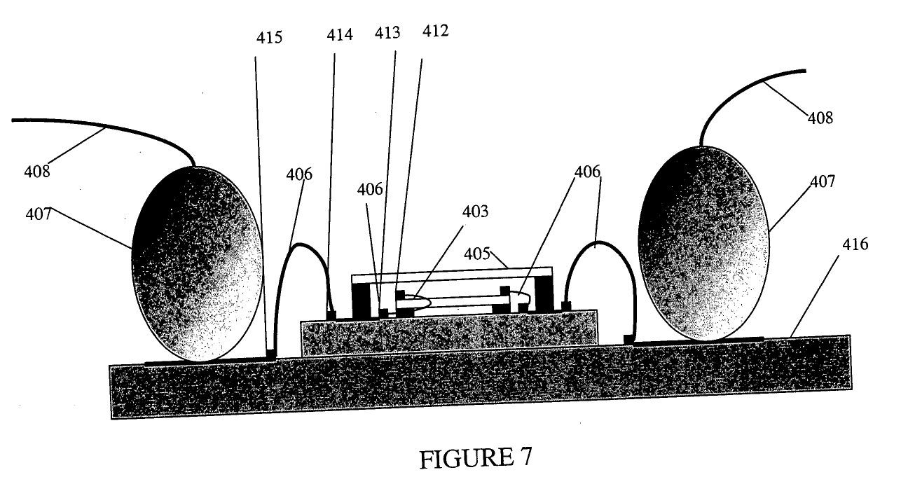

FIG. 7 is a further view of the module shown in FIGS. 5 and 6, with the external electrical contacts shown. Illustrated in FIG. 7 are wire bond pads, 451, on the integrated circuit chip, 403, and wire bond pads, 453 and 455, on the package substrate, connecting to a solder bump, 457. FIG. 6b is an alternative embodiment of the module shown in FIGS. 5 and 6, with external electrical contacts, 461, shown above the substrate and bonded to the substrate.

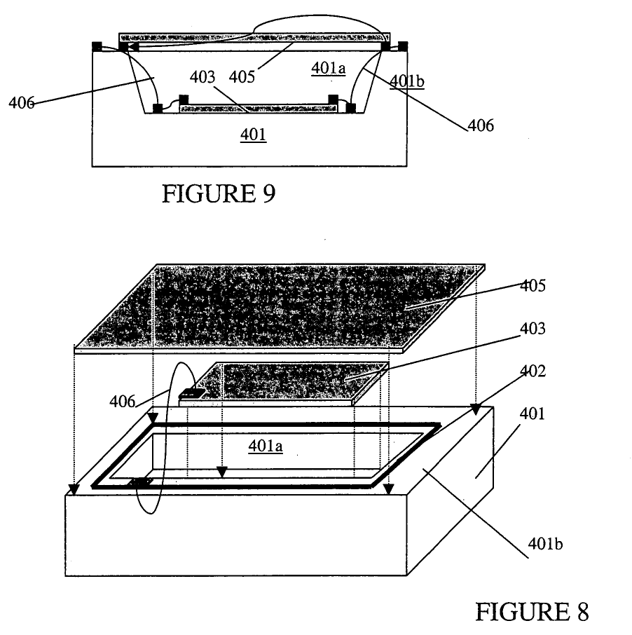

In an alternative embodiment the package is apertured or recessed, that is apertured and having a recess to receive the image sensor integrated circuit chip within the package. In this embodiment the package walls surround the image sensor integrated circuit chip, with the IR filter bonded to the package walls. This embodiment is illustrated in FIGS. 8, 9, 10, and 11.

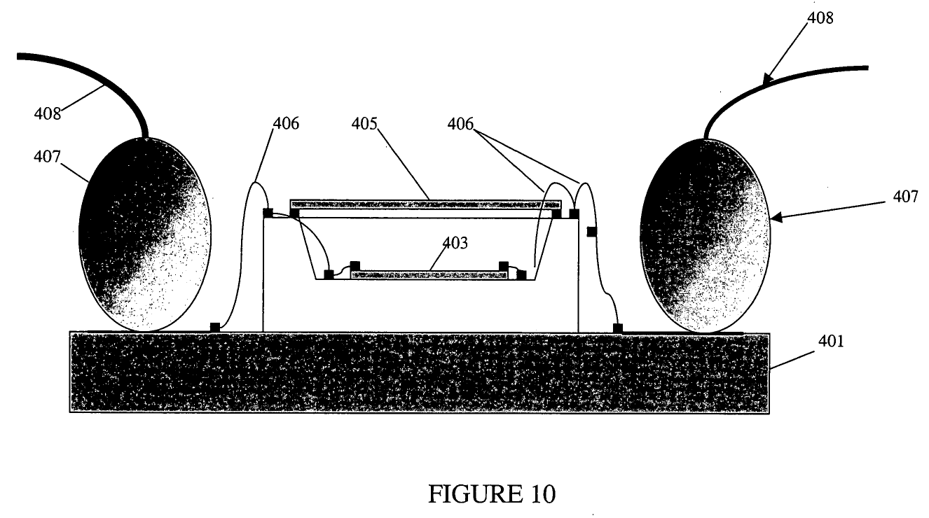

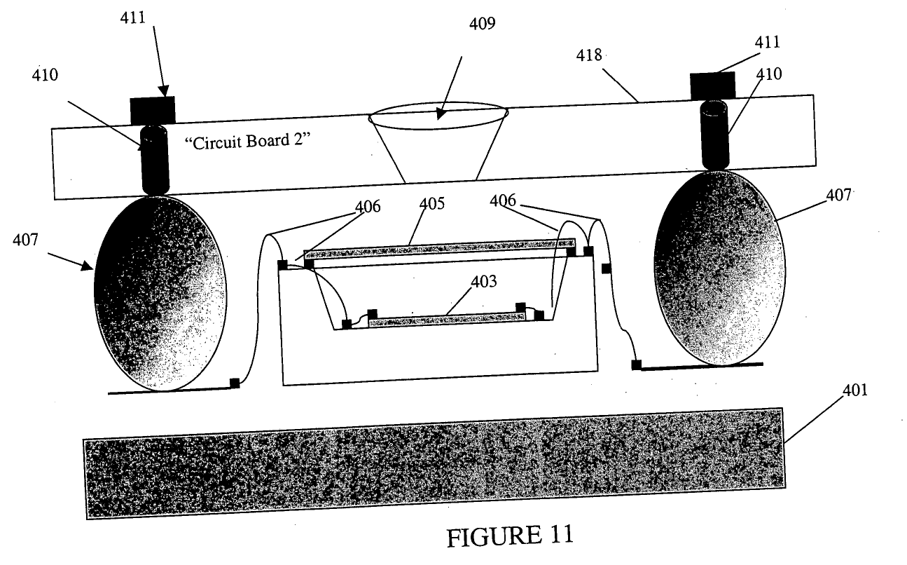

FIG. 8 is an exploded perspective view of a photosensor module of this embodiment of the invention having an image sensor integrated circuit chip, 403, mounted within the package, 401, with the recess in the package, 402. The recess in the package is adapted to receive the image sensor integrated circuit chip, 403, within the walled recess, 401b. More particularly, that is where the package walls, 401c, surround the image sensor integrated circuit chip, 403, and the IR filter, 405, is bonded to the package walls, 401c. FIG. 9 is a cutaway elevation of the photosensor module shown in FIG. 8. FIG. 10 is a further view of the module shown in FIGS. 7 and 8, with external electrical contacts shown. FIG. 11 is an alternative embodiment of the module shown in FIGS. 7 and 8, with external electrical contacts shown above the substrate and bonded to the substrate.

The IR filter or filter sheet, plate, film, or layer, 405, is hermetically sealably bonded to the package, 401. This may be a solder bond, or an adhesive bond, that is a bond affected by a cured, thermoset, or thermoplastic resin, as an epoxy resin.

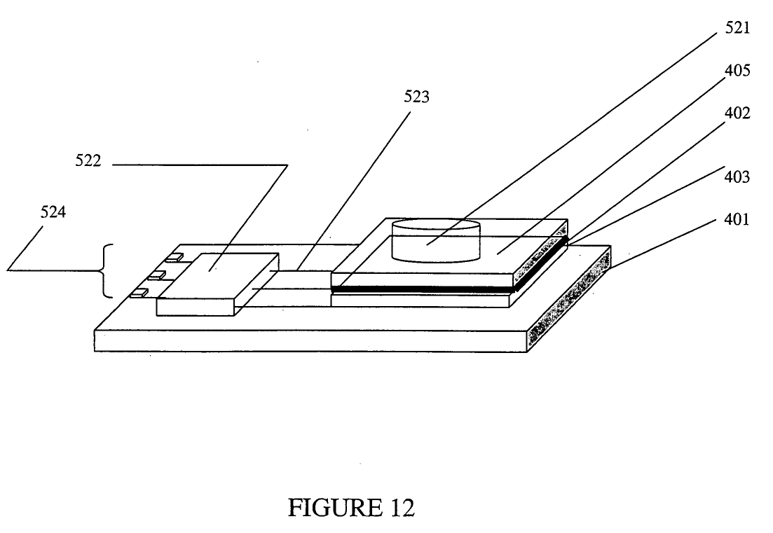

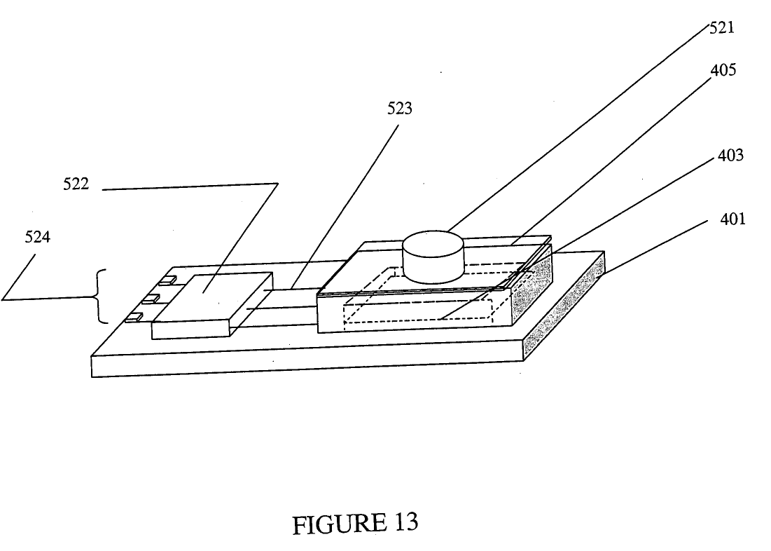

Turning to FIGS. 12 and 13, first electrical pads are address driver chip 522 connected to the sensor integrated circuit chip 403 via leads 523, and the package, 401. Also shown are second electrical pads 524 on the package for electrical connection from the package to off-package circuit components. In the embodiments shown in FIGS. 12 and 13, on-package logic is illustrated. This includes on-module image logic, 501, addressing logic, 503, and system logic/CPU, 505. Alternatively, this logic may be off-package. The module, 400, is configured for use in, for example, a digital camera, a digital camcorder, or a cellular telephone with an integrated digital camera. The module, 400, includes an integral lens assembly suitably spaced from the IR filter, 405. The lens assembly, 521, may be joined, attached, or bonded to an element of the module, 00, for example, the lens assembly, 521, may be bonded to the IR filter, 405, or the package, 401. This is illustrated in FIG. 9 in a perspective view of a module of one exemplification of the invention further including additional logic as part of the system, here an address and driver chip. FIG. 13 is a perspective view of a module of an alternative exemplification of the invention further including additional logic as part of the system, here an address and driver ship.

The structure and system has been illustrated with respect to CCD image sensors, the structure and system and fabrication methods described herein are useful with various solid state image sensors, including junction devices and CMOS devices, as well as devices and microelectromechanical devices.

As described above, a CCD comprises individual pixels, typically arranged in an X-Y matrix of rows and columns. Each pixel, in turn, comprises a photodiode and an adjacent charge holding region, which is shielded from light. The photodiode converts light (photons) into charge (electrons). The number of electrons collected is proportional to the light intensity. Typically, light is collected over the entire imager simultaneously and then transferred to the adjacent charge transfer cells within the columns.

Next, the charge is read out: each row of data is moved to a separate horizontal charge transfer register. Charge packets for each row are read out serially and sensed by a charge-to-voltage conversion and amplifier section (see image below). This architecture produces a low-noise, high-performance imager.

The structure, system, and fabrication methods of our invention are also useful with CMOS imagers. A CMOS imager is fabricated with standard silicon processes in high-volume foundries. Peripheral electronics, such as digital logic, clock drivers, or analog-to-digital converters, can be readily integrated with the same fabrication process. CMOS imager designs and fabrication technologies benefit from process and material improvements made in semiconductor technology.

The CMOS sensor's architecture is typically arranged as an x-y matrix, like a memory cell or flat-panel display. Each photosite or pixel contains a photodiode and various drive circuitry elements. The photodiode converts light to electrons. A charge-to-voltage conversion element, a reset and select transistor, and an amplifier element further constitute the pixel. A grid of metal interconnects overlays the entire CMOS sensor. This grid applies timing and readout signals, and provides an array of column output signal interconnects. The column lines connect to a set of decode and readout (multiplexing) electronics that are arranged by column outside of the pixel array. This architecture allows the signals from the entire array, from subsections, or even from a single pixel to be readout by a simple X-Y addressing technique.

Additionally, the CMOS image sensors can be stacked, for example within an integrated circuit, with different layers of the stack being sensitive to different portions of the spectrum, such as the Foveon Corp. “X3” sensor.

The CMOS structures can be amorphous Si structures, including, by way of example, Si:H and Si:H:F CMOS structures. In amorphous Si image sensors, the amorphous Si semiconductor layer by an underlaying circuit that manages addressing and data readout. Doping profiles of the amorphous Si layers determine the spectral response of the sensor.

While the structure, system, and fabrication method of our invention have been described with respect to consumer electronics, it is to be understood that these structures, systems, and fabrication methods can be used for various applications and environments, including spectral analysis devices and systems (e.g., for chemical analysis, biological assays, and astrophysics, chemical and industrial process monitoring, and the like).

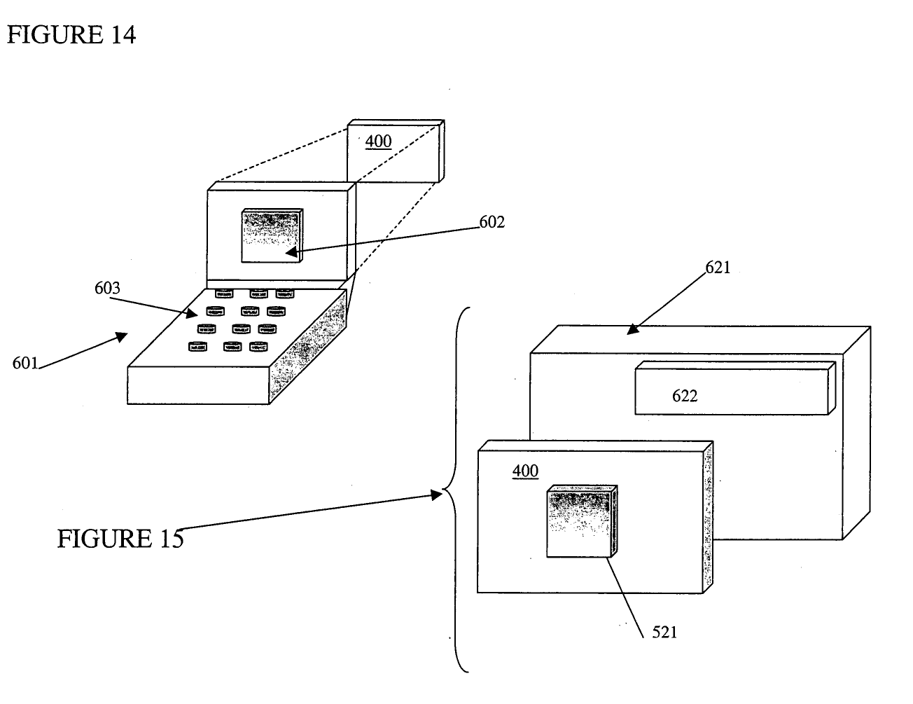

FIG. 14 shows one application of the photosensor module, 400, of the invention as a component of an integrated camera and cellular telephone, 601.

FIG. 15 shows another application of the photosensor module, 400, of the invention as a component of a digital camera, 611, including a lens assembly, 521. The lens may be movable for selective focus, such as real time, active focus. Alternatively, the lens may be fixed focus. The module may further include a display including both the physical display, as a liquid crystal display (“LCD”) and display logic. This is especially useful for integrated cell phone cameras and for digital cameras.

An adhesive, a low melting point glass, solder, diffusion bond, or some other bonding medium is then placed or activated on the seal areas where the filter sheet and the package walls are to contact and thereby define each device cavity. Precise control of the gap between the filter, the image sensor integrated circuit chip, and package walls is possible if, within the structure and ideally the seal area, there are knife edges or the joining medium contains spacing elements. Adhesives of this type, containing spheres or fibers, are available commercially.

A critical step in the assembly sequence is-to seal the through-holes and make electrical connection to the bond pads. An appropriately sized ball of solder is placed on each opening and subjected to a reflow cycle. This process step is preferably fluxless because the flux vapor and residues may contaminate the surface of the image sensor integrated circuit chip. A suitable atmosphere for conducting a fluxless reflow soldering process is dry nitrogen, optionally including chemically active species or vapors. This atmosphere will then also be that which is sealed in the package. Dry nitrogen is a suitable atmosphere to enclose in a hermetic image sensor integrated circuit chip package and thereby fulfils both roles simultaneously, although other dry, inert gases could equally be used.

Upon melting, the solder will wet the metallization on the side walls of the through-holes, thereby completing package seal. Provided the solder ball was correctly sized and the gap between the filter sheet and the image sensor integrated circuit chip was judiciously designed, there will be sufficient excess solder to protrude below the cap surface and simultaneously wet the bond pad on the device. The length and diameter of the solder interconnect together with the capacitance supplied by the metallization, define the electrical impedance of the conductor and may therefore be adjusted to suit particular applications.

For modules, 400, and image sensor integrated circuit chips, 403, that use aluminum bond pads, wetting of the solder will not naturally occur because they will be covered by a continuous layer of alumina that molten solder will not wet. On the other hand, devices made on III-V semiconductor wafers usually do not suffer from lack of wetting as the bond pads are mostly of gold; there the contrary problem exists in that low melting point tin-based solders will wet and totally dissolve the pad metallization. Three methods are available for circumventing these problems. One method is the use of source device wafers that have a under bump metallization (UBM) applied to the bond pads. This may not always be a technical or economic option. In another method, the holes in the filter sheet can be used as an in situ shadow mask so that metallization of the through-hole side walls and the bond pads occurs simultaneously. In this case, it may be necessary to protect the surface of the filter sheet from being metallized or to later remove the excess metallization to avoid short-circuiting the vias together. In yet another alternative approach, a stud bump may be applied on each bond site. Suitable equipment to do this is available commercially. The stud metal needs to be metallurgically compatible with both wire bond pad and the solder. Copper, nickel, silver, platinum and solders are possible candidates. The studs are applied to the substrate wafer before the filter sheet is bonded in place. The use of stud bumps offers the prospect of exploiting the parts of the studs that poke into the through-holes as a means for aligning the filter sheet to the image sensor integrated circuit chip.

Following sealing of the filter sheet to the package to effect hermetic closure of the hermetic cavity, by reflowing the solder balls, the package and more, the exposed side walls of the seal and its interface with the package and filter sheets can be coated with a more dense material to further improve the hermeticity.

Each hermetic sealed module can be positioned above a printed circuit board, or inverted above a printed circuit board, the solder on the module aligned with mating pads on a printed circuit board (PCB) or similar substrate and surface mounted. There are many well known options for doing this that do not require separate package attach and interconnect steps. If a very low profile is required and the original solder balls were of adequate size, attachment and electrical interconnection can be achieved by reflowing the solder that protrudes above the filter sheet. Flux may or may not be necessary. In accordance with standard surface mount practice there is obviously scope for increasing the volume of solder in the interconnects by applying solder paste, or preforms with flux, to the PCB prior to alignment and reflow. Hierarchical soldering is also possible whereby the hermetic package is sealed using a high temperature solder, but is attached to the PCB by a lower melting solder. Equally a conductive adhesive could be used at the discrete points.

As noted herein, some additional control over the physical dimensions of the solder connections, both between the filter sheet and the image sensor integrated circuit chip and between the packaged device and the surface mount PCB is possible by allowing the through-hole metallization to extend over the filter sheet surfaces.

While the apparatus, module, elements, and fabrication methods have been described and illustrated with respect to certain preferred embodiments and exemplifications, it is not intended to limit the scope of the invention thereby, but solely by the claims appended hereto and their equivalents.

1. An image sensor module comprising:
a package adapted to receive an image sensor integrated circuit chip;
an image sensor integrated circuit chip bonded to said package, said image sensor integrated circuit chip comprising:
an array of addressable, readable sensor pixels adapted to collect and store photogenerated minority carriers,
a switchable circuit for reading individual sensors;
electrical connections for receiving a driving signal for reading said individual sensors and for outputting the readings;
an infrared filter overlaying the image sensor integrated circuit chip and bonded to said package;
first electrical pads on said package for electrical connection to said image sensor integrated circuit chip; and
second electrical pads on said package for electrical connection from said package to circuit components.

2. The image sensor module of claim 1 wherein the infrared filter is sealably bonded to the package.

3. The image sensor module of claim 2 wherein the infrared filter forms a hermetic seal with the package.

4. The image sensor module of claim 2 wherein the infrared filter is solder bonded to the package at a solder joint.

5. The image sensor module of claim 2 wherein the infrared filter is bonded to the package at an organic adhesive bond.

6. The image sensor module of claim 1 wherein the infrared filter is a glass sheet.

7. The image sensor module of claim 1 wherein the infrared filter is a polymeric sheet.

8. The image sensor module of claim 7 wherein the polymeric sheet is chosen from the group consisting of polycarbonate sheets and poly diethyleneglycol bis (allyl carbonate) sheets.

9. The image sensor module of claim 1 wherein the image sensor integrated circuit chip is overlaid on said package.

10. The image sensor module of claim 9 wherein a bonding seal surrounds the image sensor integrated circuit chip.

11. The image sensor module of claim 1 wherein the package is a recessed package with a recess to contain the image sensor integrated circuit chip within the package, and package walls to surround the image sensor integrated circuit chip.

12. The image sensor module of claim 11 wherein the infrared filter is bonded to the package walls.

13. The image sensor module of claim 1 further comprising leads to off package image logic.

14. The image sensor module of claim 1 further comprising on the package image logic.

15. The image sensor module of claim 1 further comprising leads to off package addressing logic.

16. The image sensor module of claim 1 further comprising on the package addressing logic.

17. The image sensor module of claim 1 further comprising leads to off package system logic.

18. The image sensor module of claim 1 further comprising on package system logic.

19. The image sensor module of claim 1 further comprising on-package image processing logic, addressing logic, and system logic.

20. The image sensor module of claim 1 further comprising a lens assembly for forming an image on the integrated circuit chip and comprising a refractive lens element, wherein the lens assembly is joined to said module.

21. The image sensor module of claim 20 wherein the lens assembly is joined to the infrared filter.

22. The image sensor module of claim 20 wherein the lens assembly is joined to the package.

23. The image sensor module of claim 1 further comprising a display including display and display logic.

24. The image sensor module of claim 1 having a single substrate for bonding with a circuit board.

25. The image sensor module of claim 1 adapted for electrical bonding from a substrate atop the package.

26. The image sensor module of claim 1 wherein the image sensor integrated circuit chip is a CCD integrated circuit chip.

27. The image sensor of claim 26 wherein said CCD integrated circuit chip comprises:
an array of serially addressable, serially readable sensors adapted to collect and store photogenerated minority carriers,
a switchable circuit for sequentially reading individual sensors;
electrical connections for receiving a driving signal for sequentially reading said individual sensors and for outputting the sequential readings;

28. The image sensor module of claim 1 wherein the image sensor integrated circuit chip is a CMOS integrated circuit chip.

29. The image sensor module of claim 28 wherein said CMOS integrated circuit chip comprises a plurality of pixels, a pixel comprising a photodiode for converting light to electrons, a charge-to-voltage conversion section, a reset and select transistor and an amplifier section.

30. The image sensor module of claim 29 wherein said CMOS integrated circuit chip further comprises a grid of metal interconnects to apply timing and readout signals, and an array of column output signal interconnects.

31. The image sensor module of claim 30 wherein the column output signal interconnects connect to a set of decode and readout electronics.

32. An image sensor module comprising:
a package adapted to receive an image sensor integrated circuit chip;
a image sensor integrated circuit chip bonded to said package;
an infrared filter overlaying the image sensor integrated circuit chip and bonded to said package at a hermetic seal with the package;
first electrical pads on said package for electrical connection to said image sensor integrated circuit chip;
second electrical pads on said package for electrical connection from said package to circuit components; and
on-package image processing logic, addressing logic, and system logic.

33. A digital camera comprising an integrated circuit image sensor module having:
a package adapted to receive an image sensor integrated circuit chip;
an image integrated circuit chip bonded to said package;
an infrared filter overlaying the image integrated circuit chip and bonded to said package at a hermetic seal with the package;
first electrical pads on said package for electrical connection to said CCD integrated circuit chip; and
a lens assembly for a refractive lens element for forming an image on the CCD integrated circuit chip, wherein the lens assembly is joined to said module.

34. The digital camera of claim 33 wherein the lens assembly is joined to the infrared filter.

35. The digital camera of claim 34 wherein the lens assembly is joined to the package.

36. The digital camera of claim 33 further comprising a display including display and display logic.

37. A cellular telephone including an integrated circuit image sensor module having:
a package adapted to receive an image sensor integrated circuit chip;
an image sensor integrated circuit chip bonded to said package;
an infrared filter overlaying the image sensor integrated circuit chip and bonded to said package at a hermetic seal with the package;
first electrical pads on said package for electrical connection to said image sensor integrated circuit chip;
a lens assembly for a refractive lens element for forming an image on the image sensor integrated circuit chip, wherein the lens assembly is joined to said module; and
a display including display and display logic.

38. A method of hermetically encapsulating an image integrated circuit chip comprising the steps of:
providing a package having a recess defined by peripheral walls and an inner surface including a first surface for an image sensor integrated circuit chip and at least one predefined area defining an electrical contact;
placing an image sensor integrated circuit chip on the first surface of the package with an adhesive between the first surface and the image sensor integrated circuit chip;
placing a conductive material within the recess and in contact with the image sensor integrated circuit chip;
performing a heating process to:
causing the conductive material to make an electrical contact between the image sensor integrated circuit chip and the at least one predefined area defining an electrical contact to thereby electrically connect the image sensor integrated circuit chip and the at least one predefined area defining an electrical contact and
to fuse the adhesive to bond the image sensor integrated circuit chip to the first surface of the package; and
providing an infrared filtering sheet sealably on the walls of the package.

39. A method according to claim 38, further comprising applying a bond material to the package to allow a hermetic sealing between the filtering sheet and the-package.
